(19) United States
(12) Patent Application Publication
(10) Pub. No.: US 2026/0226935 A1
(43) Pub. Date: Aug. 6, 2026

(54) PRESS-IN ELEMENT, METHOD FOR FORMING A PRESS-IN CONNECTION, AND PRESS-IN CONNECTION

(71) Applicant: Richard Bergner Holding GmbH & Co. KG, Schwabach (DE)

(72) Inventors: Juliane GERSLER, Roth-Eckersmühlen (DE); Markus HIRSCHMANN, Erlangen (DE)

(21) Appl. No.: 19/567,611

(22) Filed: Mar. 16, 2026

Related U.S. Application Data
(63) Continuation of application No. PCT/EP2024/075539, filed on Sep. 12, 2024.

(30) Foreign Application Priority Data
Sep. 15, 2023 (DE) 10 2023 208 982.3

(51) Int. Cl. F16B 37/06

(52) U.S. Cl. CPC F16B 37/065; F16B 37/068

(57) ABSTRACT

A press-in connection for a pre-perforated component includes a press-in element having a head part with a head seat and a compression collar which adjoins the head part in a press-in direction. The compression collar has a base portion and a filling portion. The filling portion adjoins the base portion so as to form an internal step oriented toward a center axis. In a production process, an annular free space between an embossing collar of a die and a perforated wall is thus reliably filled with collar material through bulk deformation of the collar material, thereby ensuring good pull-out resistance as well as good resistance to torsional movement and watertightness.

### CROSS-REFERENCE TO RELATED APPLICATION

This application is a continuation, under 35 U.S.C. § 120, of copending International Patent Application PCT/EP2024/075539, filed Sep. 12, 2024, which designated the United States; this application also claims the priority, under 35 U.S.C. § 119, of German Patent Application DE 10 2023 208 982.3, filed Sep. 15, 2023; the prior applications are herewith incorporated by reference in their entirety.

### FIELD AND BACKGROUND OF THE INVENTION

The invention relates to a press-in element, in particular a press-in nut, for forming a press-in connection with a pre-perforated component, a method for forming a press-in connection, and a press-in connection.

Such a press-in element and such a press-in connection can be found, for example, in German Patent DE 10 2016 204 619 B4, corresponding to U.S. Pat. No. 11,028,868 B2. The press-in connection described therein has a high-strength component, in particular a high-strength sheet, into which the press-in element is pressed. The problem with such press-in connections is that, due to its high strength, the component itself cannot be deformed or can only be deformed very poorly.

For the purposes of the present application, a high-strength component is understood to be a component with a strength of greater than 600 MPa, in particular greater than 800 MPa, and preferably up to 2200 MPa. In addition to cold-formed steel, the component can also be made of hot-formed, press-hardened steel. The press-in element used for this purpose, in particular a press-in nut, typically has a strength of about 1000 MPa and is specifically Class 10. The (sheet) thickness and thus the wall thickness of the component is typically between 1.5 mm and 4 mm.

A special method is described in German Patent DE 10 2016 204 619 B4, corresponding to U.S. Pat. No. 11,028,868 B2, in which a compression collar of the press-in element is pressed against a perforated wall of the pre-perforated component through bulk deformation. No deformation occurs in the sense of crimping a compression collar or in the sense of a radial widening in which tangential tensile stresses are introduced. Furthermore, due to its high strength, the component itself is not deformed.

Press-in connections can also be found in German Patent DE 24 41 977 C2 or in German Application DE 10 2012 220 033 A1, for example. Each of those documents describes press-in nuts with a polygonal compression collar for preventing torsional movement. According to U.S. Publication No. 2007/0166128 A1, the hole in the component is also configured with a polygonal circumference as an additional anti-torsion safeguard.

### SUMMARY OF THE INVENTION

It is accordingly an object of the invention to provide a press-in element, a method for forming a press-in connection, and a press-in connection, which overcome the hereinafore-mentioned disadvantages of the heretofore-known devices and methods of this general type and which enable a reliable press-in connection to be formed between a press-in element and a particularly high-strength component in a process-capable manner.

The advantages and preferred embodiments mentioned in connection with the press-in element, the method, or the press-in connection are applicable to one another analogously.

With the foregoing and other objects in view there is provided, in accordance with the invention, a press-in element, particularly a press-in nut. Besides a nut, it can also be a press-in element with a through hole, particularly without an internal thread. A thread-forming screw or a threaded wire insert, for example, will later be inserted into the through hole.

The press-in element is used to form a press-in connection with a pre-perforated and, in particular, high-strength component. The press-in element extends along a center axis in a press-in direction. The press-in direction also defines a longitudinal direction. The press-in element has a head part with a typically ring-shaped head seat, which enables the press-in element to rest on a top surface of the component during the formation of the press-in connection. A compression collar, also known as a forming collar, adjoins the head part in the press-in direction. During the formation of the press-in connection, a positive fit and/or frictional fit with a hole, specifically with a perforated wall of the pre-perforated component, is formed in particular through bulk deformation.

With a view to a reliable joining process, the compression collar has a base portion adjoining the head part and a compression collar portion extending further along it in the longitudinal direction, which is referred to as the filling portion. The compression collar generally extends from the bottom side of the head part in the press-in direction and has an approximately annular shape. Therefore, both portions are also shaped in the manner of a ring. The ring can have a circular or polygonal contour, for example a hexagonal contour. The respective inner or outer surfaces of the compression collar, and thus also the corresponding inner or outer surfaces of the two portions, therefore form completely closed annular surfaces.

The filling portion connects to the base portion by forming an internal step that is oriented toward the center axis. The base portion generally has an axial base height extending in the press-in direction, from the head seat to the step. Furthermore, the filling portion generally has an axial filling height that extends from the step to a forward end of the compression collar in the press-in direction.

The term “step” generally refers to a radially extending (annular) surface between the base portion and the filling portion. Such an annular surface is therefore oriented—in comparison to the base portion and the filling portion—at a particularly substantially lower angle of inclination with respect to a horizontal plane and, in particular, runs parallel or at least substantially parallel to the horizontal plane. At least substantially perpendicular is understood to mean an angle of inclination (with respect to the horizontal plane) of a maximum of +/−20° and preferably of a maximum of +/−10°. The longitudinal direction forms a normal to the horizontal plane.

The upper end of the base portion, and thus the end of the compression collar, lies at the axial height of the head seat and is therefore defined by the head seat. The lower end of the compression collar is defined by the front, end-facing free end of the filling portion.

The compression collar still has a thread-free configuration, meaning that even when the press-in element is embodied as a press-in nut, it has no (internal) thread over its entire axial length.

During the formation of a press-in connection, the press-in element is generally inserted into the hole of the component with its compression collar facing forward, the component having a surrounding perforated wall. Using a die having a front punch region, the compression collar is formed in such a way that collar material is pressed against the perforated wall, particularly without the compression collar engaging behind the bottom side of the component. The front punch region is configured in the manner of a front embossing collar and will be referred to as such below. The component in question is, in particular, a high-strength component, specifically sheet metal with a strength as defined at the outset for the high-strength component.

During the formation of the press-in connection, a bulk deformation in three spatial directions is carried out analogously to the method described in German Patent DE 10 2016 204 619 B4, corresponding to U.S. Pat. No. 11,028,868 B2, so that the compression collar, and in particular the base portion, is compressed with the aid of the die. Collar material is pressed against the perforated wall through bulk deformation to create an interference fit with the perforated wall.

Therefore, in particular, no conventional deformation takes place in which the compression collar is widened radially outward and engages behind the bottom side of the component from below. This bulk deformation substantially involves pressure-forming of the collar material, similar to forging.

Accordingly, the total height of the compression collar, which is formed of the base height and the filling height, is preferably less than or equal to the thickness of the component into which the press-in element is to be inserted, both in the initial state before pressing-in and particularly after pressing-in. The total height is generally dimensioned such that the compression collar does not protrude beyond the bottom side of the component in the finished press-in connection.

Since the compression collar is subjected to considerable forces during the compression process, at least the compression collar is configured to be threadless along its entire length. This prevents deformation of any thread that may have been introduced during the compression process.

In general, the press-in element is therefore configured to form a press-in connection with the high-strength component, as will be described in detail below.

The descriptions of the configuration of the press-in connection in German Patent DE 10 2016 204 619 B4, corresponding to U.S. Pat. No. 11,028,868 B2, are hereby incorporated into the present application, in particular paragraphs 19 and 20 as well as 22 and 24 of German Patent DE 10 2016 204 619 B4, corresponding to column 3, lines 41-59 and column 4, lines 4-14 and 24-41 of U.S. Pat. No. 11,028,868 B2.

Due to the stepped configuration with the base portion and the filling portion, the compression collar has an offset on its radially inner side which forms a step. A central interior space enclosed on the inside by the compression collar therefore expands in a step-like manner at the transition from the base portion to the filling portion. As a result, the filling portion has a substantially lower wall thickness compared to the base portion and is overall very delicate and thin. The special advantage of this leading filling portion with its small wall thickness is that the collar material (of the filling portion) is able to penetrate deeper between the die and the perforated wall, particularly in a pressing process in which the compression collar does not penetrate or does not penetrate fully into the hole of the component at the beginning of the pressing process. The special configuration of the compression collar ensures that the collar material is reliably filled and compressed against the perforated wall as completely as possible over the entire or at least almost the entire axial length (height) of the hole.

During the formation of the press-in connection, the front filling portion therefore preferably penetrates into a free circumferential annular space (gap) between the front embossing collar of the die and the perforated wall in order to achieve the desired complete filling and compression over the entire axial length of the hole. This also means that the outer diameter of the front embossing collar is preferably smaller than the inner diameter of the hole, so that the annular gap exists.

For the deformation itself, the front embossing collar is pressed against the compression collar in the direction counter to the press-in direction, and in particular against the step. This results in bulk deformation through displacement and the resulting flow of the material. The material flows in a radial direction, thus forming an interference fit with the perforated wall. The material also partially deflects in the axial direction, so that the material flow also has an axial component which results in material flowing axially downward in the injection direction as well.

The configuration of the compression collar with base portion and filling portion is based in particular on the consideration that, for the formation of the press-in connection, the process often requires that the die first be inserted with its front embossing collar into the hole of the component from below, and that the press-in element be brought in only subsequently from above by using a suitable press punch and pressed against the die. This means that, at the beginning of the pressing process, the nut with the compression collar is not dipped into the hole, or at least not completely. The radially outer, thin filling portion now achieves the special advantage described above, namely that the filling portion penetrates into the annular free space between the perforated wall and the front embossing collar in order to reliably form the desired material compression with the perforated wall over the entire axial length of the hole.

Therefore, the preferred method for producing the press-in connection is to first insert the front embossing collar into the hole and then to press the press-in element against the die from above. At the beginning of the pressing process, the press-in element is therefore not, or at least not completely, inserted into the hole; that is, at the beginning of the pressing process, the head seat is not resting on the top of the component. At the same time, at the beginning of the pressing process, the component is already resting with one bottom side on a support surface of the die which is embodied as a ring shoulder. The ring shoulder forms a bearing surface for the die. The press-in element is therefore axially displaced toward the component during the press-in process, while the component is already supported on the die, specifically on the ring shoulder. Especially in such press-in processes, the filling portion ensures a reliable formation of a high-quality press-in connection.

In a preferred embodiment, the filling height is in the range between 20% and 100% and particularly in the range between 30% and 60% of the base height. The filling height is preferably generally less than the base height. The total height of the compression collar is preferably in the range from 1.5 mm to 4 mm, for example. It preferably corresponds to the thickness of the component (sheet thickness) or is less than the thickness of the component. This is generally preferably between 1 mm and 4 mm and particularly in the range between 1.5 mm and 3 mm.

The wall thickness (width) of the base portion and of the filling portion is respectively defined by a base thickness and a filling thickness. The base thickness and the filling thickness are each determined at half the base height and half the fill height, respectively. The filling thickness is preferably in the range between 5% and 40% and particularly in the range between 10% and 30% of the base thickness. The filling portion is therefore substantially thinner than the base portion, enabling it to penetrate into the annular gap (annular free space) between the front embossing collar of the die and the perforated wall.

In a preferred refinement, the step has a radial step width and the compression collar has a radial collar width at the level of the step, the radial step width being in the range between 20% and 80% and particularly in the range between 30% and 60% of the radial collar width. The radial collar width at the axial height of the step is composed of the radial step width and a radial width of the filling portion at this axial height.

Radial step width generally refers to the extent of the step in the radial direction. The step is generally formed by a radially extending (annular) surface between the base portion and the filling portion.

As a result, the step has a very large radial step width, so that an inner surface of the compression collar in the vicinity of the step is significantly offset radially outward.

This step generally runs preferably parallel or at least substantially parallel to a horizontal plane that is oriented perpendicular to the longitudinal direction and thus also to the center axis. Substantially parallel is understood to mean an alignment at an angle of inclination of a maximum of +/−20° and preferably of a maximum of +/−10°, referred to as the step angle.

In a preferred embodiment, the step is inclined outward, so that it falls outward in a longitudinal direction. The step angle is particularly in the range between 1° and 15° and preferably between 3° and 8°.

In one expedient embodiment, the base portion and the filling portion in their undeformed initial state-transition into one another on the outside in a stepless manner. That is, the compression collar has no step or ledge on one outer circumferential side. On the outer circumferential side, the base portion and the filling portion therefore merge seamlessly into one another. According to a preferred embodiment, the base portion and the filling portion form a common outer circumferential side that runs parallel to the center axis. Alternatively, this common outer circumferential side runs so as to be inclined at a conical angle, in particular inclined outward, relative to the center axis. The cone angle, for example, is in the range of only a few degrees (1°-10°).

As an alternative to this configuration, in which the base portion and the filling portion transition into one another in a straight line around the circumference, an outer side of the filling portion or preferably the entire filling portion (i.e., also an inner side) is oriented at an angle to the base portion and/or is inclined obliquely inward at an external angle relative to the press-in direction and thus toward the center axis. This creates a kind of insertion bevel through the filling portion which makes it easier to insert the compression collar into the hole. The outer surface or the entire filling portion is inclined, for example, at an external angle of inclination in the range between 5° to 30° and preferably in the range between 10° to 20°.

The inner side of the compression collar situated opposite the outer circumferential side is generally oriented obliquely to the center axis, or more obliquely to the center axis than the outer circumferential side. The inside is oriented diagonally downward toward the outside. An inner diameter defined by the compression collar therefore expands when viewed in the press-in direction.

The inside of the compression collar in the vicinity of the filling portion is hereinafter referred to as the lower inner portion, and the inside in the vicinity of the base portion is hereinafter referred to as the upper inner portion. The lower inner portion is preferably inclined at a lower (inner) angle of inclination relative to the press-in direction, with this lower, inner angle of inclination being particularly in the range between 10°-40° and especially between 15° and 30°. The lower inner portion is, in particular, inclined obliquely outward (positive lower angle of inclination). Alternatively, it can also be inclined diagonally inward (negative lower angle of inclination).

The upper inner portion is preferably inclined obliquely outward at an upper (inner) angle of inclination, which is preferably in the range between 10°-40° and in particular between 15° and 30°.

Preferably, the lower inner portion and the upper inner portion run parallel to one another or at least largely parallel to one another and have, for example, angles of inclination that differ by a maximum of +/−20°.

In a preferred refinement, an upper wall portion adjoins the upper inner side opposite the press-in direction which runs more steeply than the upper inner side with respect to the press-in direction and, for example, extends to a cylindrical shape. The upper wall portion has a smaller angle of inclination compared to the upper inner side.

The steeper angle of the upper wall portion offers the special advantage of creating a kind of recess, resulting in less material being present in the upper wall portion. In particular, this prevents material from being displaced inward during the pressing process and, for example, deforming a thread formed there.

As already mentioned at the outset, the press-in element is in particular a press-in nut which therefore has a through hole with an internal thread. The internal thread ends, as viewed in the press-in direction, particularly before the base portion begins. In particular, the internal thread ends before or at the beginning of the upper wall portion.

In general, in a fully formed press-in connection, the head part with its head seat rests directly on a top surface of the component and thus on a surrounding edge of the hole.

In a preferred embodiment, the compression collar has a polygonal and, in particular, a hexagonal outer contour to form an anti-torsion mechanism. Preferably, the entire head part has such a polygonal outer contour.

The hole in the component preferably has the same polygonal circumferential contour as the compression collar.

In order to form the press-in connection, the following steps are preferably carried out - particularly in addition to the previous explanations:

According to a preferred variant, the component is first placed on the die, and in particular on an annular shoulder of the die, so that the front embossing collar dips into the hole. The press-in element is then pressed against the die from above. The embossing collar designates and defines a predetermined embossing contour.

The front embossing collar preferably has a radially outwardly extending end face which is pressed against the step during the pressing process and exerts an axial forming force thereon, resulting in the desired radial material displacement and shaping. The front surface is particularly rectilinear. In addition or as an alternative, it runs horizontally or slopes outward.

The front surface preferably transitions via a transitional region into a circumferential side of the front embossing collar. The transitional region is beveled or rounded.

During the pressing process, the end face pushes the material of the compression collar upward, thereby pushing the compression collar outward against the edge of the hole. The transitional region of the die serves in particular to shape the connection so that the die does not stick to the press-in connection and/or so that the die does not break on a sharp edge. The collar material is redirected here, but not bent outward. This involves a flowing of the collar material.

The dimensions of the front embossing collar and of the compression collar are coordinated in such a way that, at the beginning of the pressing process, the filling portion reaches the transitional region with its lower inner portion and is reliably guided through the same during the pressing process, so that the filling portion is able to reliably penetrate into the circumferential gap between the front embossing collar and the perforated wall.

The bulk deformation of the compression collar is initiated by the die with its (straight) end face. When the element strikes the front surface, the compression collar is compressed upward and thus also flows radially to the edge of the hole. This crimps the collar material between the edge of the hole and the die. The collar material flows around the radius formed on the outside and through the transitional region. Conventional bending does not occur, i.e., the die does not bend the material of the compression collar outward.

Therefore, during the formation of the press-in connection, the end face acts on the step in the direction counter to the press-in direction. This results in bulk deformation and thus in a flowing of the collar material, so that it penetrates into the gap, i.e., the circumferential ring or free space, and is pressed radially against the perforated wall. Preferably, only an axial force component is applied to the step. In particular, no radial expansion occurs.

In an expedient refinement, the end face is embodied as an annular surface, which is bounded inward toward the center axis by a ring collar projecting axially in the direction counter to the press-in direction, which is also referred to as a contour collar. This prevents the collar material from being displaced inward toward the center axis. This ensures that the material of the compression collar is reliably pressed radially outward against the perforated wall.

In general, the geometries of the compression collar, the embossing collar and the hole are matched to one another within tight tolerances, so that at least one and preferably all of the following properties are achieved in the press-in connection:
The head rests directly on a top side of the component.
The press-in element does not protrude beyond the bottom side of the component.
The bottom side is not reached by the compression collar.
The compression collar pressed against the perforated wall extends at most over the entire or at least almost the entire axial length of the perforated wall. “Almost the entire length” is understood to mean a deviation of a maximum of 10% and preferably a maximum of 5%. Preferably, however, the compression collar extends over the entire length.
The component is undeformed in the vicinity of the hole, meaning that a hole edge on the bottom side is not bent over/pulled up, so that a part of the compression collar optionally engages behind the bent part.
The component is a high-strength component.
The component is a pre-perforated component.

The hole is formed before the pressing process by a suitable hole-forming process, in particular by shear cutting (punching). For components made of hot-formed steel, the hole-forming process can optionally take place before or after the heat treatment of the component. Alternatively, a laser cutting process can also be employed. Furthermore, the hole may have been created in the component through mechanical processing such as milling or drilling. The edges of the holes run substantially parallel to the center axis. Particularly during the punching process, when a punch is pushed through the component in the press-in direction, a slight tearing or breakout occurs on the bottom side at an edge of the perforated wall due to the process, so that the perforated wall widens radially there (i.e., particularly only in the lower half or in the lower two-thirds) at a slight angle of inclination of a few degrees). In addition, the surface of the perforated wall is roughened in this torn-out portion, i.e., at the fracture surface. This widening and radial pressing against the perforated wall achieves sufficient pull-out resistance in the axial direction counter to the press-in direction.

The press-in element is particularly a press-in nut. Alternatively, it can also be a press-in pin. In this configuration, a shaft, in particular a threaded shaft, is attached to the head part and extends along the center axis in the press-in direction. The shaft is surrounded by the compression collar with its special geometry, including a base portion and a joining portion, typically leaving an annular gap.

Other features which are considered as characteristic for the invention are set forth in the appended claims.

Although the invention is illustrated and described herein as embodied in a press-in element, a method for forming a press-in connection, and a press-in connection, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a fragmentary, diagrammatic, cross-sectional view illustrating the method for forming the press-in connection with a press-in nut as the press-in element, a pre-perforated component, and a die at the beginning of the process, in which the component is placed on the die and the press-in nut is subsequently pressed in;

FIG. 2 is a fragmentary, cross-sectional view analogous to FIG. 1 in a later stage of the pressing process at which the press-in nut strikes the die;

FIG. 3 shows a further fragmentary, cross-sectional view during the further course of the pressing-in process in which the press-in nut is fully pressed in;

FIG. 4 is a top-plan view of the press-in nut;

FIG. 5 is a bottom-plan view of the press-in nut;

FIG. 6 is an enlarged view of the portion designated as A in FIG. 1;

FIG. 7 is an enlarged view of the portion designated as B in FIG. 1; and

FIG. 8 is an illustration analogous to FIG. 6 of an alternative variant.

### DETAILED DESCRIPTION OF THE INVENTION

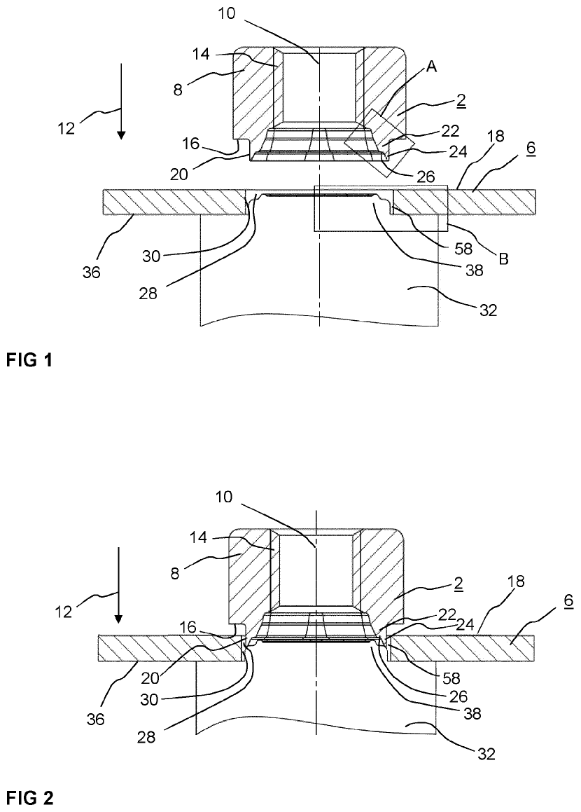

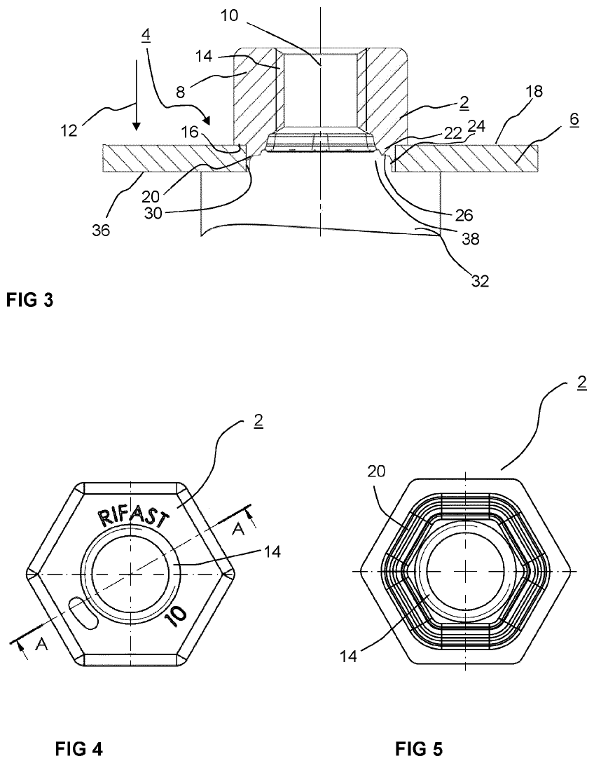

Referring now in detail to the figures of the drawings, in which functionally identical parts are denoted by the same reference symbols, and first, particularly, to FIG. 1 thereof, there is seen a press-in element which is embodied as a press-in nut 2. This press-in nut 2 is used to form a press-in connection 4, as shown in FIG. 3, with a pre-perforated component 6 that is embodied as a sheet metal part, using a press-in process as described and shown in FIGS. 1 to 3.

The press-in nut 2 generally has a head part 8 which extends along a center axis 10 in a press-in direction 12, which also defines a longitudinal direction. The press-in nut 2 has a central through hole in which an internal thread 14 is formed. In the press-in direction 12, a head seat 16 is formed on the bottom side of the head part 8, forming a step which is formed by a circumferential, ring-shaped bearing surface. In the press-in connection 4, the head seat 16 rests on a top surface 18 of the component 6.

Starting from the head seat 16, a circumferential and ring-shaped compression collar 20 extends in the press-in direction 12. The compression collar 20 is divided into an upper base portion 22 and a lower filling portion 24. The two portions 22 and 24 merge into one another, forming a step 26.

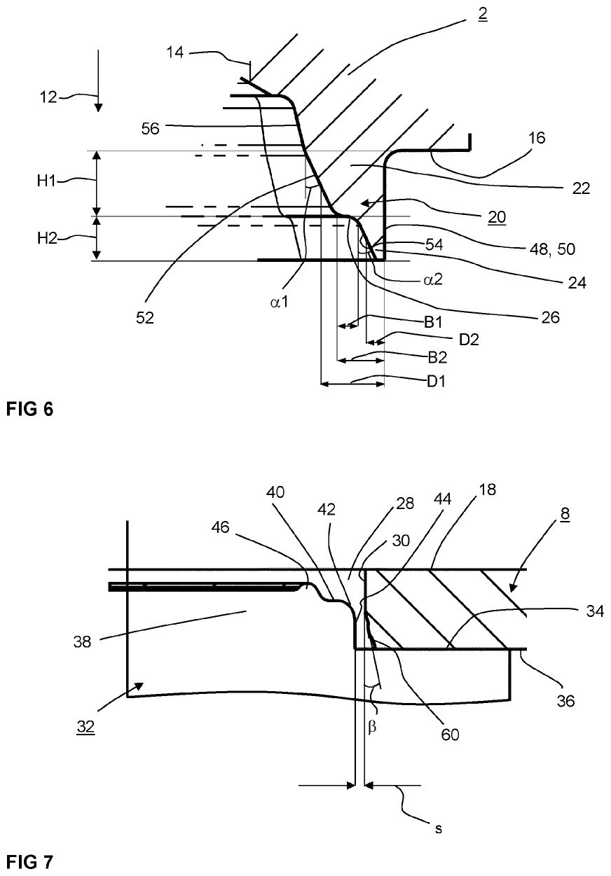

The exact geometry of the press-in nut 2 in the vicinity of the compression collar 20 will be explained in greater detail below with reference to the enlarged representation of FIG. 6.

The component 6 is embodied as a high-strength, pre-perforated steel sheet, with strengths as defined at the beginning. It has a hole 28 with a perforated wall 30 into which the press-in nut 2 is pressed.

The pressing process is carried out by using a die 32. The structure thereof is evident particularly from the enlarged illustration in FIG. 7. The die 32 has an annular shoulder 34 at its front end on which the component 6 rests with a bottom side 36 during the pressing process. In the central inner area, the die 32 has a front embossing collar 38 which protrudes in the direction counter to the press-in direction 12 and dips into the hole 28 from the bottom side 36 during the pressing process.

The embossing collar 38 has an end-face annular surface 40 (end surface) which transitions via a particularly rounded transitional region 42 into an outer circumferential side 44 of the embossing collar 38 which then adjoins the horizontally extending ring shoulder 34. In the exemplary embodiment, the transitional region 42 has a comparatively large radius. Alternatively, the transitional region can be more angular and have a smaller radius.

Radially inward, a ring collar 46 which projects axially in the direction counter to the press-in direction 12 adjoins the end face of the annular surface 40.

In the exemplary embodiment, the die 32 is made of solid material. Alternatively, it can also be hollow inside, particularly for inserting a press-in bolt.

As can be seen in particular from the illustrations according to FIG. 4 and FIG. 5, the press-in nut 2 in the exemplary embodiment has a polygonal and in particular hexagonal cross-sectional contour. Both the head part 8 and the compression collar 20 exhibit this polygonal structure. Correspondingly, the hole 28 and the embossing collar 38 each have a corresponding polygonal structure.

Wherever there is mention of ring-shaped structures such as annular gaps or ring-shaped compression collars, these are understood to be corresponding polygonal ring structures.

As an alternative to the polygonal structure, the compression collar 20, the head part 8, and also the hole 28 and the embossing collar 38 can be circular. The polygonal structure provides an especially high level of resistance to torsional movement. FIG. 4 shows a sectional line A-A. The sectional views of FIGS. 1-3 as well as FIG. 6 each show at least partial sections of the cut surfaces along this section.

The special configuration of the press-in nut 2 in the vicinity of the compression collar 20 will now be explained in detail with reference to FIG. 6: The base portion 22 extends over a base height H1 starting from the horizontally running head seat 16 to the axial height of the step 26.

In the exemplary embodiment, the step 26 runs horizontally and thus perpendicular to the center axis 10. Alternatively, it can also be inclined slightly outward, in which case it assumes an acute step angle to the horizontal plane, i.e., to a plane perpendicular to the press-in direction 12 or perpendicular to the center axis 10. This acute step angle lies between 1° and a maximum of 20° and preferably between 3° and 8°. In the case of an inclined step 26, the axial height of the step 26 is defined by a mean axial height. The step 26 is generally formed by an annular surface.

The filling portion 24, which extends over a filling height H2, is adjacent to this step 26. In this exemplary embodiment, the filling height H2 is somewhat different from the base height H1 and is, for example, 70%-90% of this base height H1. Alternatively, the filling height H2 is only 20% to 40% of the base height H1. The two heights H1 and H2 together form the total height of the compression collar 20. This preferably corresponds to the thickness of the component 6 (sheet thickness). Alternatively, the total height of the compression collar is less than the thickness of component 6.

In some variants, particularly with thin sheets (for example those with a sheet thickness of 2 mm or less), the total height of the compression collar 20 in the initial state is also greater than the sheet thickness.

In other variants, particularly with thick sheets (for example those with a sheet thickness of greater than or equal to 2 mm), the total height of the compression collar 20 in the initial state as well as in the pressed final state is less than the sheet thickness, so that a lower end of the compression collar 20 is offset from the bottom side of the sheet. This offset is between 0.2 mm and 0.6 mm, for example.

In the pressed state, i.e., when the press-in connection has been formed, the compression collar 20 does not protrude beyond the bottom side of the component in any case.

The base portion 22 has a base thickness D1 in the middle of the base height H1, i.e., at the mean base height H1. Correspondingly, the filling portion 24 has a filling thickness D2 in the axial center of the filling height H2, i.e., at the mean filling height H2, which is substantially less than the base thickness D1. For example, it lies only in the range between 10% and 30% or, alternatively, only in the range of 30% to 50% of the base thickness D1.

The step 26 has a comparatively high radial step width B1 overall. The radial step width B1 is understood to be the width of the step 26 at the axial height of the step 26. The compression collar 20 has a total radial collar width B2 at this height. In the exemplary embodiment, the step width B1 is, for example, in the range between 40% and 60% or, alternatively, in the range between 20% and 40% of the collar width B2.

The base portion 22 and the filling portion 24, and thus the compression collar 20 as a whole, together form an outer circumferential side 48 which, in the exemplary embodiment of FIG. 6, runs parallel to the center axis.

Alternatively, it is also possible for the entire circumferential side 48 to slope diagonally inward.

For example, the entire circumferential side 48 of the compression collar 20 is inclined inward toward the center axis 10 or, alternatively, only an outer side 50 of the filling portion 24 or of the filling portion 24 as a whole. This serves to improve the insertion into the gap between the perforated wall 30 and the embossing collar 38 of the die during processing.

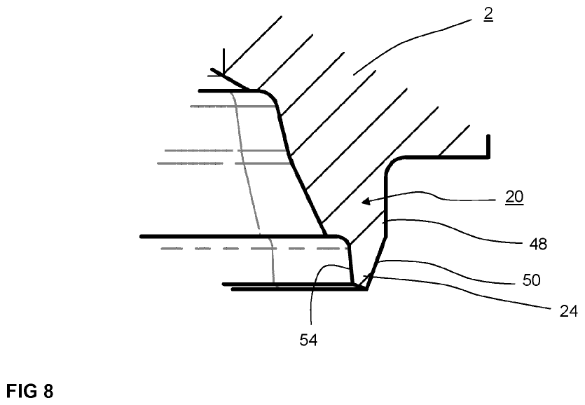

In the variant according to FIG. 8 modified from FIG. 6—starting from the variant of FIG. 6—the entire filling portion 24 is inclined inward. In the exemplary embodiment shown in FIG. 8, this results in the outer surface 50 of the filling portion 24 being inclined obliquely inward and thus toward the center axis. In the exemplary embodiment shown in FIG. 8, the inside of the filling portion 24, and thus the lower inner portion 54, is oriented parallel to the center axis. This is not mandatory, however.

According to one configuration variant, an upper portion of the circumferential side 48 in the vicinity of the base portion 22 is parallel to the center axis 10, and a lower portion of the circumferential side 48 in the vicinity of the filling portion 24, which thus forms an outer side 50 of the filling portion 24, is oriented obliquely inward at an external angle of inclination with respect to a parallel to the center axis.

This outer surface 50 therefore forms a kind of insertion bevel. This external angle of inclination is preferably in the range of 5° to a maximum of 30°. If the entire outer surface 50 is inclined, the external angle of inclination is preferably in the range between 10-20%, and if only the filling portion 24 is inclined, it is in the range of 10-30%.

In the exemplary embodiment, one inner side of the compression collar 20 is inclined obliquely outward. The inner side is divided into an inner side of the base portion 22, which is referred to as the upper inner portion 52, and an inner side of the filling portion 24, which is referred to as the lower inner portion 54. These two portions 52, 54 are inclined obliquely outward at an upper angle of inclination α1 and a lower angle of inclination α2, respectively, relative to the center axis 10. These angles of inclination α1, α2 are preferably in the range between 10° and 40°. The two angles of inclination α1, α2 are, for example, identical or preferably differ from one another only by a maximum of +/−20° or a maximum of 5°.

In the alternative embodiment in which the outer surface 50 is inclined

obliquely inward in the manner of an insertion bevel, the lower angle of inclination α2 is less than the upper angle of inclination α1 by the outer angle of inclination (preferably +/−max. 40° or max. 5°).

The two portions 52 and 54 merge into one another via the step 26. The transitions are preferably rounded.

Counter to the press-in direction 12, a slightly steeper angled upper wall portion 56 adjoins the upper inner portion 52. This is part of an intermediate portion between the compression collar 20 and the beginning of the internal thread 14.

The internal thread 14 is axially spaced apart from the compression collar 20. The axial distance is, for example, in the range between 0.5 times and 1.5 times the base height H1. This measure ensures that the thread 14 is not deformed during the deformation. This ensures that the dimensional accuracy of the thread 14 is reliably guaranteed after pressing-in.

The press-in connection 4 is preferably formed as follows:

In a first step, the die 32 is inserted from below into the hole 28 until the component 6 comes to rest with its bottom side 36 on the ring shoulder 34. This situation is illustrated in FIG. 1 and particularly also in FIG. 7. The press-in nut 2 is still located outside of the hole 28.

Subsequently, the press-in nut 2 is moved in the press-in direction 12, inserted into the hole 28 with the compression collar 20 leading (FIG. 2), and pressed against the die, specifically against the embossing collar 38, until the head seat 16 comes to rest on the top surface 18 of the component 6 (FIG. 3).

With the press-in nut 2 described herein, it is also possible in principle to first insert the press-in nut 2 into the hole 28 with the compression collar 20 until the head seat 16 comes to rest on the top 18 and only then to bring the die in from below and press it against the compression collar 20 in order to deform it.

However, the special advantage of the press-in nut 2 arises in the previously described process in which the die 32 is first inserted into the hole 28.

In any case, the dimensions are chosen at least such that an annular free space 58 (annular gap) is formed between the embossing collar 38, and in particular the circumferential side 44 thereof, and the perforated wall 30. The radial outer dimension of the compression collar 20, and thus the circumferential side 48 thereof is also dimensioned such that a free space remains toward the perforated wall 30. The clearance s of the free space 58 between the circumferential side 44 of the embossing collar 38 and the perforated wall 30 is preferably 0.1 mm to 0.6 mm or, in particular for larger dimensions (e.g., larger than M10), up to 1 mm. Preferably, the compression collar 20 has the same clearance from the perforated wall 30 in the undeformed initial state or, alternatively, it is even slightly larger, for example by up to 20%.

In general, the filling portion 24 has a radial outer dimension at its front end that is adapted to the radial outer dimension of the embossing collar 38 insofar as the filling portion 24 rests with its front end on the transitional region 42 of the embossing collar 38. Subsequently, the annular surface 40 of the embossing collar 38 reaches the step 26 and preferably exerts only an axial force thereon, so that the desired bulk deformation takes place and material of the base portion 22 is displaced radially outward by flowing. The flowing process initially displaces the material in a radial direction and presses it against the perforated wall 30. Subsequently, axial force components also become active, so that the material of the filling portion 24, which meanwhile has been dipped into the annular free space 58, also experiences an axial force component and is thus pressed farther into the annular free space 58, fills it by material flow, and is also pressed against the perforated wall 30 in a radial direction.

The frontal arrangement of the comparatively thin filling portion 24, which already dips into the annular free space 58 before the actual bulk deformation, reliably ensures that the annular free space 58 is filled with material and, in particular, that pressure is applied against the perforated wall 30 preferably over the entire length of the perforated wall 30, even in the described process situation in which the embossing collar 38 is first inserted into the hole 28.

Overall, this results in a process-capable and reliable press-in connection 4 with high pull-out resistance and good torsional stability. Furthermore, the press-in connection 4 is generally watertight.

The perforated wall 30 is specially shaped by a punching operation in such a way that it widens slightly toward the bottom side 36 and, in particular, is torn out or broken out, forming a fracture surface 60. The bottom side 36 is also a bottom side in the punching process, meaning that the punching die is driven from above from the top side 18 in the press-in direction 12 toward the bottom side 36 through the component 6. The fracture surface 60 is exaggerated in FIG. 7 for the sake of illustration. This fracture surface 60 is usually oriented at a fracture surface angle β to the center axis 10. The axial height typically extends over a maximum of ⅔ of the thickness of the component 6.

The material of the compression collar 20 and, in particular, of the filling portion 24 is pressed into this radial widening of the hole 30 formed by the fracture surface 60. The axial pull-out resistance is therefore decisively influenced and ensured by the special configuration of the filling portion 24.

The punching process described above often also deforms the perforated wall 30 in the vicinity of the top 18, so that the perforated wall 30 also has an indentation on the top side 18.

In some applications, it is required that the hole punching process and the pressing-in of the press-in nut 2 be carried out from different directions, meaning that the punching process is carried out in the direction from the top side 18 to the bottom side 36, whereas the press-in nut 2 is inserted from the bottom side 36 of the component 6 in the direction of the top side 18.

In this variant of the method, in which a punching operation and the pressing operation are carried out from opposite directions, the filling portion 24 provides material compression against the (slightly) widened perforated wall 30 in the vicinity of the top side 18 and thus achieves axial pull-out resistance in this case as well.

The following is a summary list of reference numerals and the corresponding structure used in the above description of the invention:
2 press-in nut
4 press-in connection
6 component
8 head part
10 center axis
12 press-in direction
14 internal thread
16 head seat
18 top side
20 compression collar
22 base portion
24 filling portion
26 step
28 hole
30 perforated wall
32 die
34 ring shoulder
36 bottom side
38 embossing collar
40 annular surface
42 transitional region
44 circumferential side of the embossing collar
46 ring collar
48 circumferential side of the compression collar 20
50 outside of the filling portion
52 upper inner portion
54 lower inner portion
56 upper wall portion
58 annular free space
60 fracture surface
H1 base height
H2 filling height
D1 base thickness
D2 filling thickness
B1 radial step width
B2 radial collar width
α1 upper angle of inclination of the upper inner portion
α2 lower angle of inclination of the lower inner portion
β fracture surface angle
s clearance

1. A press-in element or press-in nut extending in a press-in direction along a center axis for forming a press-in connection with a pre-perforated component, the press-in element comprising:
a head part with a head seat for resting on the pre-perforated component; and
a compression collar adjoining said head part in the press-in direction;
said compression collar having a thread-free configuration and a front end in the press-in direction, a base portion and a filling portion, said filling portion adjoining said base portion to form an internal step oriented toward the center axis;
said base portion having an axial base height extending from said head seat to said step, and said filling portion having an axial filling height extending from said step to said front end of said compression collar.

2. The press-in element according to claim 1, wherein said axial filling height is in a range of between 20% and 100% of said axial base height.

3. The press-in element according to claim 1, wherein said base portion has a base thickness at half of said base height, said filling portion has a filling thickness at half of said the filling height, and said filling thickness is in a range of between 5% and 40% of said base thickness.

4. The press-in element according to claim 1, wherein said step has a radial step width and said compression collar has a radial collar width at a level of said step, and said radial step width is in a range of between 20% and 80% of said radial collar width.

5. The press-in element according to claim 1, wherein said base portion and said filling portion transition into one another on an outside in a stepless manner.

6. The press-in element according to claim 1, wherein said base portion and said filling portion form a common circumferential side running parallel to the center axis.

7. The press-in element according to claim 1, wherein an outer side of the filling portion is inclined obliquely inward in the direction of the center axis, preferably at an outer angle of inclination in the range between 5° and 30°.

8. The press-in element according to claim 1, wherein said filling portion has an inner side designated as a lower inner portion being inclined obliquely outward relative to the press-in direction at a lower angle of inclination, and said lower angle of inclination is in a range of between 10° and 40°.

9. The press-in element according to claim 8, wherein said base portion has an inner side designated as an upper inner portion being inclined obliquely outward relative to the press-in direction at an upper angle of inclination, and said upper angle of inclination is in a range of between 10° and 40°.

10. The press-in element according to claim 9, which further comprises an upper wall portion adjoining said upper inner portion counter to the press-in direction, said upper wall portion being steeper than said upper inner portion and extending to a cylindrical shape.

11. The press-in element according to claim 1, wherein said compression collar has a polygonal or hexagonal outer contour.

12. A method for producing a press-in connection between a press-in element and a pre-perforated component, the method comprising:
providing said press-in element according to claim 1;
providing said pre-perforated component having a hole defining a circumferential perforated wall;
dipping said press-in element with said compression collar into said hole; and
forming said compression collar by using a die having a front embossing collar, causing material of said front embossing collar to press against said perforated wall.

13. The method according to claim 12, which further comprises preventing said compression collar from engaging behind a bottom side of said pre-perforated component.

14. The method according to claim 12, which further comprises causing said filling portion to penetrate into an annular free space between a circumferential side of said front embossing collar and said perforated wall.

15. The method according to claim 12, which further comprises initially placing said pre-perforated component on said die and dipping said front embossing collar into said hole, and then pressing said press-in element from above against said die.

16. The method according to claim 12, which further comprises pressing a radially extending end face of said front embossing collar against said step.

17. The method according to claim 16, which further comprises transitioning said radially extending end face via a rounded or beveled transitional region into a circumferential side of said front embossing collar, and providing an annular clearance between said circumferential side and said perforated wall at a beginning of a pressing process.

18. The method according to claim 16, which further comprises using said radially extending face to act on said step in a direction counter to the press-in direction and to press said material of said front embossing collar into a circumferential annular free space between said front embossing collar and said perforated wall by bulk deformation.

19. The method according to claim 16, which further comprises providing said radially extending face as an annular surface being bounded inwardly toward the center axis by a ring collar, preventing displacement of said material of said front embossing collar inward in a direction of the center axis.

20. A press-in connection, comprising:
a press-in element or press-in nut produced according to claim 12;
said press-in element extending in a press-in direction along a center axis for forming the press-in connection with a pre-perforated component;
said press-in element including:
a head part with a head seat for resting on the pre-perforated component; and
a compression collar adjoining said head part in the press-in direction;
said compression collar having a thread-free configuration and a front end in the press-in direction, a base portion and a filling portion, said filling portion adjoining said base portion to form an internal step oriented toward the center axis;
said base portion having an axial base height extending from said head seat to said step, and said filling portion having an axial filling height extending from said step to said front end of said compression collar.
